(19) United States
(12) Patent Application Publication
(10) Pub. No.: US 2004/0125438 A1
(43) Pub. Date: Jul. 1, 2004

(54) Microscope

(76) Inventors: Heinz Studer, Blons (AT); Ewald Hiller, Dornbirn (AT)

Correspondence Address: HODGSON RUSS LLP, ONE M & T PLAZA, SUITE 2000, BUFFALO, NY, 14203-2391, US

(21) Appl. No.: 10/689,959

(22) Filed: Oct. 21, 2003

(30) Foreign Application Priority Data
Oct. 22, 2002 (DE) 102 49 904.7

(51) Int. Cl. G02B 21/00

(52) U.S. Cl. 359/368; 359/391

(57) ABSTRACT

A microscope (10) which comprises at least one magazine (30) with receiving areas for accommodating assemblies, assemblies for such a microscope (10), a process for carrying out investigations with a microscope (10) and a computer program and a computer program product are described. The microscope (10) described comprises transponders associated with the assemblies inserted in the receiving areas and a reader unit for reading data stored in the transponders.

### CROSS-REFERENCE TO RELATED APPLICATIONS

The present application claims priority of German patent application number 102 49 904.7 filed Oct. 22, 2002, which is incorporated herein by reference.

### BACKGROUND OF THE INVENTION

The invention relates to a microscope having at least one magazine with receiving areas for accommodating assemblies and an assembly for a microscope of this kind. The invention further relates to a method of carrying out investigations or measurements with a microscope and a computer program and a computer program product for carrying out the process according to the invention.

In known microscopes, various optical assemblies such as, for example, filters, slides and objectives may be used and the assemblies required for the particular application have to be inserted in the optical path. During a measuring operation it may in some cases be necessary to change optical assemblies. In order to make this changeover easier so-called magazines have proved useful which serve to accommodate a number of assemblies at the same time.

These magazines generally have a number of receiving areas into which the assemblies can be inserted. It is useful to have one magazine for the filters, one for the slides and one for the objectives.

In this way, for example, all the filters needed in an investigation process can be accommodated in a magazine, a so-called filter wheel. This filter wheel can be moved manually or by a motor so that the filter required can be placed in the optical path as necessary.

For measuring fluorescence it may be necessary for safety reasons, for example, to place filters in the optical path in order to protect the user. In such an investigation it is essential to ensure that the correct filter is placed in the optical path before a shutter is opened. The shutter must only be opened once the required filter is in the optical path. In order to identify the filters it is known to write on them. The written label and the corresponding characteristic data are entered manually in a databank. The updating of this databank must always be checked, particularly if there are any changes in the filter characteristics, to prevent mix-ups. In automated procedures it is necessary to file the filters in the correct place in the magazine. In automatic operation the characterizing data in the databank cannot be checked. However, it is precisely for automated processes that the application must be able to be stopped automatically or not started at all if there is an incorrect combination of assemblies in the optical path.

### SUMMARY OF THE INVENTION

The object of the present invention is therefore to provide a microscope which meets the above safety requirements and allows reliable automatic operation.

This object is met by a microscope which has at least one magazine with a number of receiving areas for accommodating optical assemblies, wherein transponders are associated with the assemblies inserted in the receiving areas and a reader unit is provided for reading the data filed in the transponders.

The reader unit will thus at all times pick up the data from the transponders associated with the assemblies situated in the optical path at this moment. During fluorescence measurements, for example, a check is first made to see whether the necessary filter has been placed in the optical path. Only when it is certain that the correct filter has been placed in the optical observation and illumination path is the preferably electrically operated shutter opened.

According to one feature of the microscope according to the invention a writer unit is provided which serves to write data in the transponder. This writer unit can be used to record data in transponders. Preferably, a combined reader and writer unit is used.

The microscope according to invention thus permits contactless filter identification, with the possibility of data transmission in both directions. In this way it is possible, for example, to find out how often a particular slide has been examined in order to stop the measurement once a given threshold has been exceeded, if necessary.

The magazines are preferably movable by means of motors.

Preferably, a control unit is provided for controlling the processes as a function of the data read.

The microscope according to the invention is particularly suitable for fluorescence measurements and can be constructed as a stereomicroscope. In this case, in the so-called fluorescence module of the microscope, a writer/reader unit is incorporated in the electronics and the transponders are placed on the filter carriers. When the filter is rotated into the position of the visual optical path, the writer/reader unit transmits the identification demand to the transponder or to the electronic label which normally takes its energy supply from the electrical field and then transmits the specific filter basic data to the writer/reader unit. The data can then be applied to an internal bus system in the control apparatus by an electronic computing unit, e.g. a microcontroller, and is thus available to the application software.

The assembly according to the invention is used in particular in a microscope as described above and comprises, for example, at least one filter or one slide. The assembly is characterized in that it has a transponder associated with it.

The process according to the invention for carrying out investigations or measurements with a microscope having at least one magazine with receiving areas for receiving assemblies envisages that transponders will be associated with the assemblies inserted in the receiving areas. These transponders can be read by a reader unit. In operation, the transponders which are associated with the assemblies located in the optical path will be read. The investigation will then be carried out in accordance with the data read off.

If it is established that an incorrect combination of assemblies or an unsuitable filter has been placed in the optical path, the investigation can be stopped. In the case of fluorescence measurement, for example, the shutter used is operated as a function of the data read in.

In an embodiment of the process according to the invention data are written into transponders by means of a writer unit.

The data read in may also be stored in a memory unit. The current operational state can then be reconstructed at a later time as the components are recognized by the transponders and this information can be stored. The use of the transponders can also be used to pick up operational data which may be useful for statistical evaluations such as, for example, determining the life of the filters or the number of investigations carried out on a particular preparation.

The computer program according to the invention comprises program coding means for carrying out all the steps of the process according to the invention when the computer program is run on a computer or a corresponding computing unit, particularly a computing unit in a control device for controlling the processes in a microscope.

The computer program product according to the invention comprises these program coding means which are stored on a computer-readable data carrier.

The invention allows automatic recognition of the filters inserted in a filter wheel in a motorized stereomicroscope. A contactless filter identification of the blocking and excitation filters located in the filter wheel or filter revolver is thus possible. It is also possible for data to be transmitted in both directions in full duplex operation. Data read off can be deposited in a non-volatile write-protected memory. As an additional safety measure the data may be encrypted. In contrast to the known practice of writing on filters, additional information such as tolerance data may also be stored. There is no need to manage the data as the data is automatically updated.

The microscope according to the invention has a simple structure and small dimensions. It is particularly suitable for automated measuring sequences as the data detected which characterize the assemblies used serve as control signals and ensure safe and reliable operation of the microscope.

Further features and embodiments of the invention will become apparent from the specification and the accompanying figures.

It will be appreciated that the features mentioned above and those which are described hereinafter may be used not only in the combination given but also in other combinations or on their own without departing from the scope of the present invention.

### BRIEF DESCRIPTION OF THE DRAWINGS

The invention is illustrated by means of exemplifying embodiments in the drawings and is explained in detailed hereinafter with reference to the figures, in which:

FIG. 1 shows a preferred embodiment of the microscope according to the invention shown diagrammatically;

FIG. 2 shows a filter wheel as an example of a filled magazine of the microscope according to the invention, shown diagrammatically;

FIG. 3 shows a flow chart as an example of the process according to the present invention; and

FIG. 4 shows a flow chart as an example of the shutter function according to a process of the present invention.

### DETAILED DESCRIPTION OF THE INVENTION

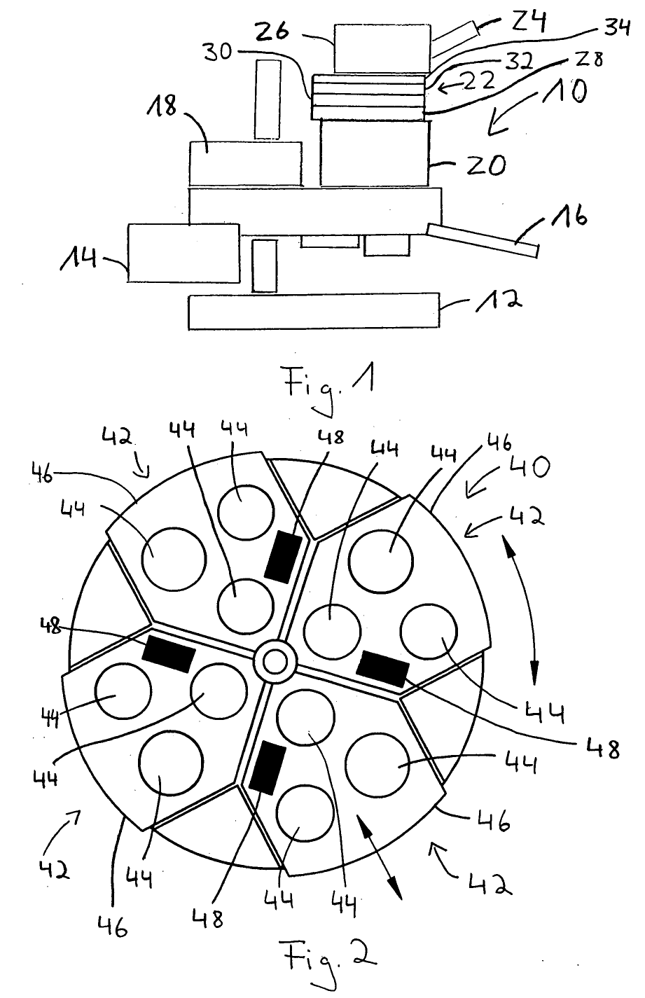

In FIG. 1 there is an illustration of a preferred embodiment of the microscope according to the invention which is generally designated by reference numeral 10.

The drawing shows a motorized base 12, an automatic lighting unit 14, a pivotable UV filter 16, a motor-driven focusing unit 18, a motor driven zoom unit 20, a fluorescence unit 22, an eyepiece 24 and a tube 26.

In the fluorescence unit 22 is a shutter 28, a filter wheel 30 with filters which are associated with transponders, a writer/reader unit 32 and an electronic control unit 34. The writer/reader unit 32, after delivering a demand for identification, reads data from the transponder associated with the filter in the optical path. These data are passed on to the control unit 34 and then applied to the internal bus system and are thus available to the application software.

If it is established that a filter which is suitable for the proposed investigation is located in the optical path the shutter 28 is opened. If this is not the case the process is not started or is automatically stopped.

FIG. 2 shows a filter wheel 40 as an example of a filled magazine of the microscope according to the invention, shown diagrammatically in plan view.

The filter wheel 40 has four receiving areas 42 into each of which is inserted a filter carrier 46 loaded with filters 44. A transponder 48 is provided on each of the filter carriers 46. These transponders 48 are consequently associated with the filters 44.

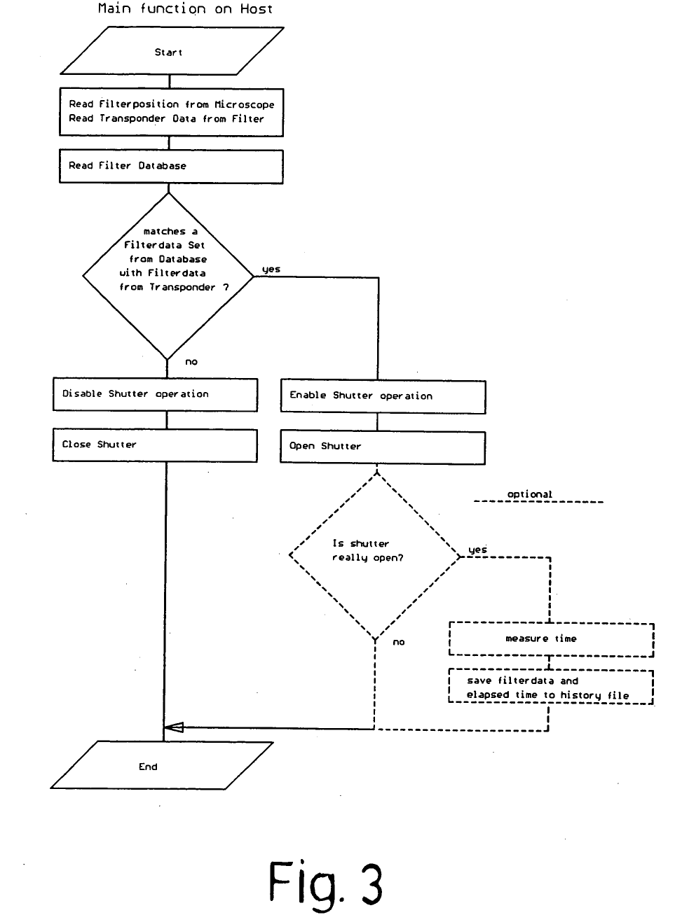

FIG. 3 shows a flow chart representing an example of a main function carried out by a process according to the present invention. After starting the process, in general the filter position may be read from the microscope and transponder data from the filter. If, however, the transponder is associated with the filter, the filter position can be established by reading the transponder data. In a second step, the filter database is read off. If a filter data set from the database matches with the filter data read from the transponder, shutter operation will be enabled. Otherwise, any shutter operation will be disabled and the shutter be closed.

After enabling shutter operation, the shutter is opened and the microscope investigation is started. As an optional step the opening of the shutter is double checked and a time (e.g. time needed for investigation) is measured. The measured time and the filter data may be written to a history file.

Any reading or writing operations are preferably carried out by the writer/reader unit 32 of FIG. 1, the process is preferably controlled by a computer program performed on the control unit 34 shown in FIG. 1. For storing information a memory unit is provided. This memory unit may be included in a transponder or may be part of the control unit 34.

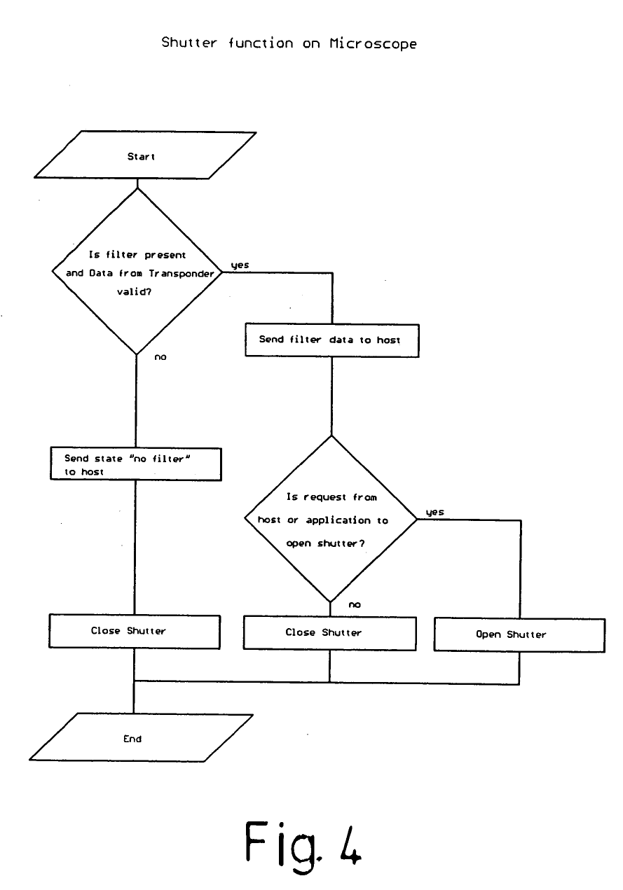

FIG. 4 shows a flow chart of another example of a process according to the present invention. In order to control the shutter function, it is first examined whether a filter is present and whether data read from the transponder associated with the filter are valid. If yes, the filter data are sent to the host which may be part of the control unit 34 shown in FIG. 1. In case of an existing request to open the shutter, the shutter will then be opened and the investigation may be started. Otherwise the shutter will be closed. On the other hand, should no filter be present or data read from the transponder be not valid, the status “no filter” will be sent to the host. This would result in closing the shutter.

List of Reference Numerals

10 Microscope

12 Base

14 Lighting unit

16 UV filter

18 Motor driven focusing unit

20 Zoom unit

22 Fluorescence unit

24 Eyepiece

26 Tube

28 Shutter

30 Filter wheel

32 Writer/reader unit

34 Control unit

40 Filter wheel

42 Receiving area

44 Filter

46 Filter carrier

48 Transponder

What is claimed is:

1. A microscope comprising:
an optical path;
a magazine having a plurality of receiving areas;
a plurality of assemblies, each of said plurality of assemblies being accommodated by a respective one of said plurality of receiving areas for selective positioning in said optical path by operation of said magazine;
a plurality of transponders associated one with each of said plurality of assemblies, wherein each of said plurality of transponders includes stored data; and
a reader unit for reading said stored data of a transponder associated with an assembly positioned in said optical path.

2. The microscope according to claim 1, further comprising a writer unit for writing data into any one of said plurality of transponders.

3. The microscope according to claim 1, wherein each of said plurality of assemblies includes a slide.

4. The microscope according to claim 1, wherein each of said plurality of assemblies includes a filter.

5. The microscope according to claim 1, further comprising a motor connected to said magazine for moving said magazine.

6. The microscope according to claim 1, further comprising an electronic control unit connected to said reader unit for controlling processes as a function of said data read by said reader unit.

7. The microscope according to claim 1, further comprising an electronically operated shutter for selectively blocking said optical path.

8. The microscope according to claim 1, wherein said microscope is designed for fluorescence measurements.

9. The microscope according to claim 1, wherein said microscope is a stereomicroscope.

10. An assembly adapted to be held by a magazine of a microscope, said assembly comprising:
at least one component intended to be positioned in an optical path of said microscope by operation of said magazine; and
a transponder located elsewhere on said assembly from said at least one component.

11. The assembly according to claim 10, wherein said at least one component includes a filter.

12. The assembly according to claim 10, wherein said at least one component includes a slide.

13. A process for carrying out a selected investigation using a microscope having at least one magazine with receiving areas for respectively accommodating assemblies, said magazine enabling a chosen assembly to be positioned in an optical path of the microscope, said process comprising the steps of:
providing transponders respectively associated with said assemblies, each of said transponders including stored data;
reading said stored data of a transponder associated with an assembly in said optical path; and
conducting said investigation in accordance with said read data.

14. The process according to claim 13, further comprising the steps of reading reference data corresponding to said selected investigation, comparing said read data with said reference data, and stopping said investigation if said read data does not match said reference data for said selected investigation.

15. The process according to claim 13, wherein data are written into said transponders by a writer unit.

16. The process according to claim 13, wherein a fluorescence measurement is carried out.

17. The process according to claim 13, wherein a shutter is operated based on said read data.

18. The process according to claim 13, further comprising the step of storing said read data.

19. The process according to claim 18, further comprising the step of using said read data that have been stored to provide operational data.

20. A computer-executable process comprising the steps of:
reading data provided by a transponder associated with a filter in an optical path of a microscope;
reading filter data from a database, said filter data corresponding to a selected microscopy investigation;
comparing said data provided by said transponder with said filter data; and
opening a shutter in said optical path if said data provided by said transponder match said filter data.

21. A computer-readable storage medium storing computer executable instructions for performing the steps of:
reading data provided by a transponder associated with a filter in an optical path of a microscope;
reading filter data from a database, said filter data corresponding to a selected microscopy investigation;
comparing said data provided by said transponder with said filter data; and
opening a shutter in said optical path if said data provided by said transponder match said filter data.
